(19) United States
(12) Patent Application Publication
(10) Pub. No.: US 2015/0279150 A1
(43) Pub. Date: Oct. 1, 2015

(54) METHODS AND SYSTEMS FOR MAINTAINING CUSTOMER LOYALTY

(71) Applicant: KIZZANG LLC, Las Vegas, NV (US)

(72) Inventor: Robert Alexander, Las Vegas, NV (US)

(21) Appl. No.: 14/531,901

(22) Filed: Nov. 3, 2014

Related U.S. Application Data
(63) Continuation-in-part of application No. 14/231,364, filed on Mar. 31, 2014.

(51) Int. Cl. G07F 17/32

(52) U.S. Cl. CPC G07F 17/326

(57) ABSTRACT

A sweepstakes provides an initial qualifying event to a player and upon receiving an indication that the player has successfully completed the qualifying event, provides a new qualifying event to the player until each qualifying event of the sweepstakes is completed. When each qualifying event of the sweepstakes is completed, a prize may be presented to the player. If each qualifying event of the sweepstakes is not completed, the player may be presented with new or previously presented qualifying events for completion. A sweepstakes also provides a virtual prize wheel having segments populated with prizes available to be won by a player, wherein a number of prize wheel segments of the prize wheel representing prizes available to be won by the player are populated based on an outcome of a prize selection process.

### RELATED APPLICATIONS

This is a CONTINUATION IN PART of and incorporates by reference U.S. application Ser. No. 14/231,364, filed Mar. 31, 2014.

### FIELD OF THE INVENTION

The present invention relates to on-line gaming, and more specifically to a sweepstakes for use in connection with an on-line service as a means of ensuring customer loyalty to the service.

### BACKGROUND

Merchants commonly use sweepstakes as a means of generating repeat customers. For example, some restaurants employ sweepstakes in which game pieces are provided to customers on each visit and the customers use the game pieces to win (or attempt to win) prizes. Some states also use sweepstakes as a means of offering “second chances” to win lottery prizes, thereby driving demand for lottery tickets. In such instances, the prizes associated with the sweepstakes are generally fixed at the time the sweepstakes promotion commences and do not change regardless of the number of entries a player submits.

### BRIEF DESCRIPTION OF THE DRAWINGS

The present invention is illustrated by way of example, and not limitation, in the figures of the accompanying drawings, in which:

FIG. 1 illustrates an example of a network environment within which embodiments of the invention may be instantiated.

FIG. 2 illustrates an example of a web page including an advertisement that may be provided by a server to a client in accordance with embodiments of the invention.

FIG. 3 illustrates an example of a web page that includes a virtual prize wheel that may be provided by a server to a client in accordance with embodiments of the invention.

FIG. 4 illustrates further details of the virtual prize wheel shown in FIG. 3.

FIG. 5 illustrates an example of a control system for the virtual prize wheel shown in FIGS. 3 and 4.

FIG. 6 illustrates an example of a computer system in which embodiments of the invention may be instantiated.

FIG. 7 illustrates an exemplary process for providing a sweepstakes opportunity to a player.

FIG. 8 illustrates an example of a web page that includes an exemplary visual representation of a player's progress through a set of qualifying events.

FIG. 9 illustrates an exemplary process for providing a sweepstakes opportunity to a player.

FIG. 10 illustrates an example of a web page that includes an exemplary prize selection mechanism.

### DETAILED DESCRIPTION

In various embodiments, the present invention provides methods and systems for maintaining customer loyalty. In one instance, the present invention provides a sweepstakes for use in connection with an on-line service as a means of ensuring customer loyalty to the service. The sweepstakes may be instantiated in various forms. In one such form, a virtual prize wheel is presented to a player and one or more segments of the virtual prize wheel are populated with prizes available to be won by the player. The prizes may include passes that allow the player to play one or more on-line games (e.g., games of chance, other sweepstakes, entertainment games, etc.), coupons (e.g., for merchandise, services, or the like), goods or services, and/or cash. A player “turn” may consist of two virtual spins of the virtual prize wheel. A first spin of the virtual prize wheel may determine how one or more segments of the virtual prize wheel are populated—that is, which prizes are associated with one or more of the virtual prize wheel segments. A second spin of the virtual prize wheel may determine the prize(s) won by the player for the specified turn. Players may be afforded one or more turns per visit to the on-line service and/or per time period, for example up to a predetermined number of turns per day, in exchange for viewing one or more advertisements or fulfilling other specified conditions. Player loyalty (e.g., in the form of multiple return visits to one or more web sites associated with the on-line service) may be encouraged by varying the prizes available to be won. For example, in one embodiment of the invention the number of virtual prize wheel segments, the number of such segments populated with cash prizes, and the value of those cash prizes are varied according to a predetermined schedule, with the prizes, prize values and virtual prize wheel segments being reset to a set of initial conditions if a player fails to participate in a qualifying event for a virtual prize wheel turn within a designated time period. These and further details of the present invention are described in greater detail below.

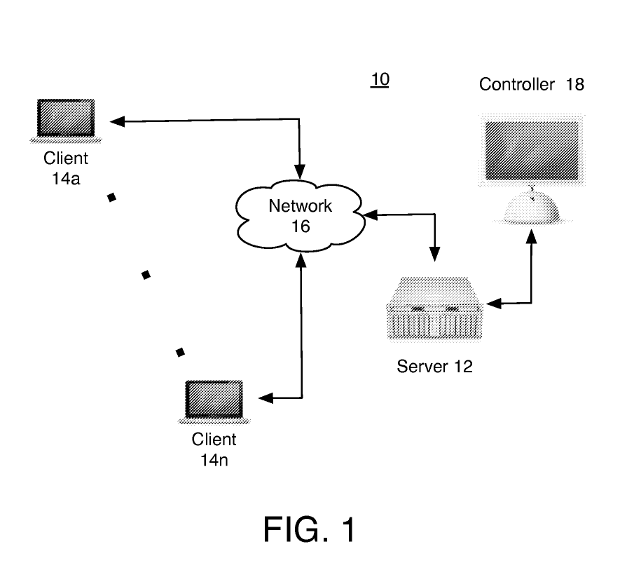

Before describing the present invention in detail it is helpful to provide an overview of the environment in which embodiments of the invention may be deployed. FIG. 1 illustrates an example of such an environment 10. In this example, server 12 hosts an on-line service through which any of a variety of goods or services may be purchased and/or used. For example, server 12 may host one or more web sites offered by a service provider, which web sites offer on-line games for users. The games may include entertainment games, casino games, wagering games, etc. Alternatively, or in addition, movies, music or other forms of entertainment may be accessed through one or more of these web sites. Also, the web sites may offer goods or other services for lease or purchase by visitors. Indeed, the nature of the web sites hosted by server 12 is not critical to the present invention, however, it is preferable that the web sites be offered only to visitors that have registered for access to same, thereby allowing individual users to be identified each time they visit. Although illustrated as a single server, it should be appreciated that server 20 may in fact be multiple servers and may be segregated into web servers that are communicably coupled to one or more application servers, which themselves are communicably coupled to one or more databases storing user information, game information and other data.

Users (and herein the term player may be used interchangeably with the term user) access web sites and other facilities hosted by server 12 through clients 14a-14n. Examples of such clients include desktop computers, laptop computers, cellphones, smart phones, tablet computers, computer game consoles, portable computer gaming consoles, media players, portable media players, other mobile devices, and the like. Typically, clients 14a-14n communicate with server 12 over one or more networks 16, for example the Internet. Clients 14a-14n are preferably configured with applications that allow for the display of web pages. Such applications include web browsers and dedicated applications capable of rendering web pages and the like.

Also shown in FIG. 1 is a controller 18 that is communicably coupled to server 12. Controller 18 is a facility for the service provider associated with the web sites hosted at server 12 to maintain and otherwise configure those sites. In some instances, controller 18 may communicate with server 12 via network 16, while in other cases the communication may be over a virtual private network or the like and so is shown as a separate connection in the diagram.

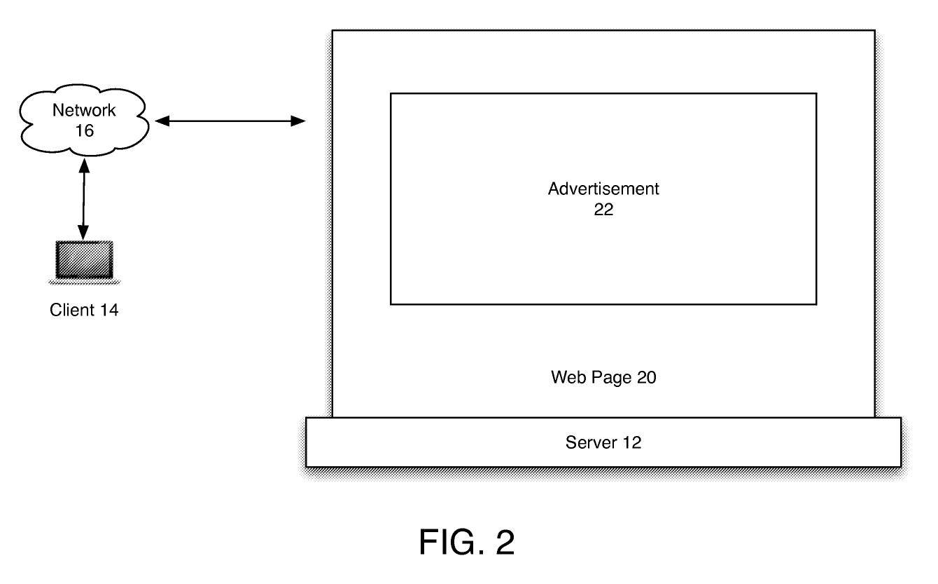

Referring now to FIG. 2, when a player at client 14 accesses a service associated with a web site hosted at server 12, the player may be required to log-in (e.g., by presenting a user name and password). Upon successful verification of the player's credentials, a web page 20 that includes an advertisement 22 may be presented. Viewing the advertisement 22 (or multiple such advertisements) may be a condition of being permitted access to the services associated with the web sites hosted by server 20 and the player's agreement to view such advertisements may be part of the terms of service agreed to by the player when he/she enrolls with the service provider. The advertisement 22 may be any form of advertisement and may comprise one or more images, text materials, movies, audio-video presentations, etc. Although the user may be provided an opportunity to “skip” the advertisement and navigate directly to other web pages, server 12 is preferably configured to detect such navigation commands (typically in the form of mouse click or similar events associated with a hyperlink away from web page 20). Upon recognizing such a navigation command, server 20 will not present the player an opportunity to spin the virtual prize wheel and any accumulated loyalty grants may be eliminated from the player's account.

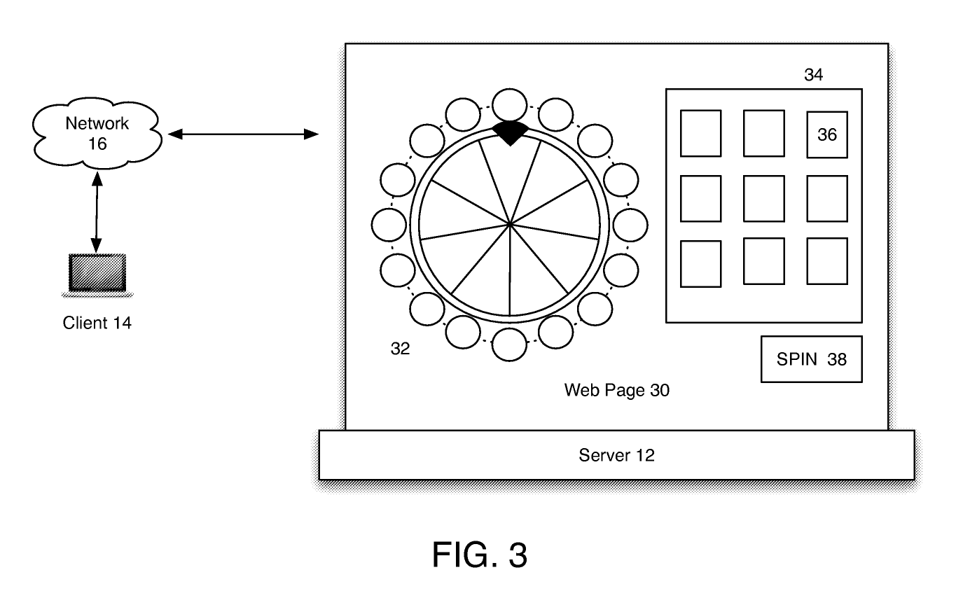

Assuming the player views the advertisement through its conclusion (e.g., if the advertisement is a movie or audio-video presentation) or for at least a designated period of time (e.g., specified by a count down timer or the like displayed in conjunction with web page 20), server 12 will present web page 30, shown in FIG. 3, to the player (e.g., via a web browser associated with client 14). Web page 30 includes the virtual prize wheel 32 and an associated information panel 34. In one embodiment, information panel 34 may include designators 36 that indicate the schedule for modifying the virtual prize wheel and/or possible cash prizes associated therewith. For example, the designators may be calendar days or the like. Web page 30 may also include a virtual spin button 38, which when selected by a user (e.g., with a mouse click or similar cursor control action) may cause the virtual prize wheel 32 to spin. In other embodiments spin button 38 may be absent and the virtual prize wheel may be activated automatically by server 12 (e.g., a predetermined time after the web pages has been loaded by the browser running on client 14).

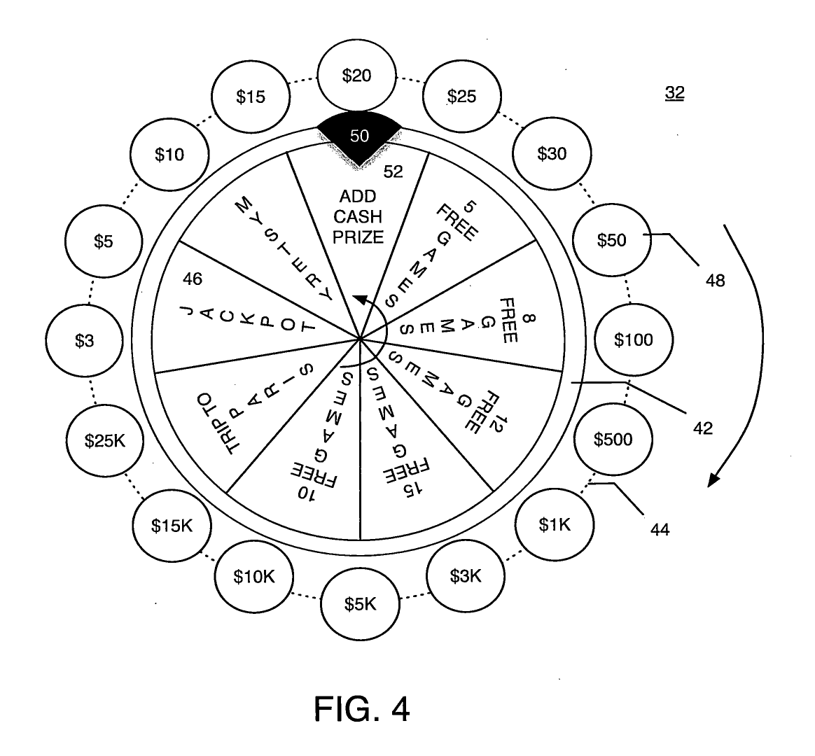

FIG. 4 illustrates an example of the virtual prize wheel 32 in greater detail. In this example, virtual prize wheel 32 includes an inner wheel 42 and an outer wheel 44. The inner wheel 42 includes a plurality of segments 46, each associated with a prize. Prizes may include trips, merchandise, services, coupons for merchandise or services, passes or other tokens that allow for free game play (or other services) at the associated web site (e.g., games of chance, other sweepstakes, entertainment games, etc.), etc. Jackpot prizes (e.g., cumulative cash amounts not won during previous spins of the wheel), mystery prizes (where the prize is revealed only after the wheel stops) and other prizes may also be designated. At least one segment 52 is designated as an “ADD CASH PRIZE” segment.

Outer wheel 444 includes a plurality of cash prize indicators 48. The cash prize indicators are each associated with designated cash amounts. The cash amounts may range in value from low dollar values to high dollar values. The illustrated embodiment shows cash prizes of $3, $5, $10, $15, $20, $25, $30, $50, $100, $500, $1,000 (designated as $1K in the illustration), $3,000, $5,000, $10,000, $15,000, and $25,000, but this is merely an example and in practice any cash values may be used. Cash prizes may, in some instances, be progressive (across prior player turns from prior visits, across all player turns in a given time period, across all turns of all players on a given day, etc.)

At the top of the virtual prize wheel (or in another location), is an indicator 50. Indicator 50 serves to distinguish both a cash prize to be added to the virtual prize wheel (during a first spin of a player turn) and a prize to be awarded (during a second spin of a player turn). As indicated above, a player turn consists of two spins of the virtual prize wheel. The first spin of the virtual prize wheel causes both wheels to spin (e.g., in opposite, or the same direction(s) as one another about a common central axis). When the wheels come to a stop, the cash prize amount designated by the cash prize indicator pointed to by indicator 50 is added to segment 52 of the inner wheel 42 (at the conclusion of the first spin, segment 52 is always stopped so that it is pointed to by indicator 50). Once the cash value has been so added, the second spin of the virtual prize wheel may cause one or both of the inner and outer wheels to spin (e.g., in the same or opposite directions as one another about a common central axis). When the wheel(s) come to a stop, the prize associated with the inner wheel segment 46 pointed to by indicator 50 is awarded to the player. Spins may be initiated by the player by selecting the spin button 38 (if present) or may be initiated automatically by server 30. Each player may be afforded one or more turns per visit to the on-line service and/or per time period (e.g., every 8 hours), for example up to a predetermined number (e.g., 3) of turns per day, in exchange for viewing one or more advertisements or fulfilling other specified conditions.

As mentioned above, player loyalty (e.g., in the form of multiple return visits to one or more web sites associated with the on-line service) may be encouraged by varying the prizes available to be won. In one embodiment of the invention, the number of virtual prize wheel segments 46, the number of such segments populated with cash prizes 52, and/or the value of those cash prizes may be varied according to a predetermined schedule. For example, the number of prize segments 46 may be increased each day, every other day, weekly, semi-monthly, monthly, quarterly, semi-annually, or according to another schedule, up to a maximum number of segments (e.g., 20) within a given 365-day period. Alternatively, or in addition, the number of cash prize segments 52 to be populated may be increased each day, every other day, weekly, semi-monthly, monthly, quarterly, semi-annually, or according to another schedule, up to a maximum number of cash prize segments within the 365-day period. Still further, the values of the cash prizes may be varied, with larger cash prizes being available for inclusion in the cash prize segments 52 on a daily, weekly, semi-monthly, monthly, quarterly, semi-annually, or other basis, up to a set of maximum cash prize values within the 365-day period. In one particular embodiment, the number of segments 46 and the number of cash prize segments 52 are varied according to the schedule shown in Table 1.

TABLE 1
Example of Prize Wheel Variations

| | # of Prize Wheel | # of Cash Prize |
|---|---|---|
| DAY | Segments | Segments |
| 1 | 9 | 1 |
| 2 | 10 | 2 |
| 3 | 11 | 3 |
| 5 | 12 | 4 |
| 7 | 13 | 5 |
| 10 | 14 | 6 |
| 14 | 15 | 7 |
| 30 | 16 | 8 |
| 45 | 17 | 9 |
| 60 | 18 | 10 |
| 75 | 19 | 11 |
| 90 | 20 | 12 |
| 120 | 20 | 13 |
| 150 | 20 | 14 |
| 240 | 20 | 15 |
| 365 | 20 | 20 |

It is worth noting that in the above example represented in Table 1, the variations among virtual prize wheel segments and the number of cash prize segments is designed to entice players to visit the site regularly for long periods of time (e.g., at least daily for 365 consecutive days. In this example, players are notified that prize values and virtual prize wheel segments will be reset to their initial conditions (i.e., day 1 conditions of 9 virtual prize wheel segments with 1 cash prize segment) if a player fails to participate in a qualifying event for a virtual prize wheel turn (e.g., visit the web site and view at least one advertisement through completion) within a designated time period (e.g., a 24 hour period). The number of virtual prize wheel segments is increased according to the above schedule until a total of 20 segments are included on the virtual prize wheel. Concurrently, the number of cash prize segments is increased according to a second schedule such that on day 365 all 20 of the virtual prize wheel segments are cash prize segments (i.e., the player is assured of winning a cash prize). The cash prize segments may be populated in accordance with the above-described method (e.g., as the result of a first spin of the virtual prize wheel in a given turn). In some cases, all cash prize segments may be populated as a result of the first spin (in which case multiple indicators 50 may be used for cash prize segment population) or the cash prize segments may be populated using a umber of spins, with each spin populating a single cash prize segment. In this latter instance, cash prizes from outer wheel 44 used to populate one cash prize segment 52 may or may not be reused in successive spins to populate other cash prize segments 52.

In other embodiments, rather than having a virtual prize wheel populated in the above-described fashion, on day 365 the player may be presented with a new virtual prize wheel having only cash and prizes available to be won. In some instances, a first spin of the wheel may be used to determine a number of cash prize and or other prize spins awarded to the player, in which instance the cumulative total of these spins would be the player's awarded prize.

After a complete cycle of virtual prize wheel segment and cash prize segment variations, e.g., on day 366 in any of the above-described examples, the virtual prize wheel may be replaced by a different form of sweepstakes, by a different form of virtual prize wheel, or an alternative customer loyalty encouragement device. It should be appreciated that the time periods described in the above examples are solely for purposes of illustration and in practice any schedule desired by the service provider may be used. Players having different loyalty levels (e.g., attained through visits to the subject web site or to affiliate web sites or establishments) may be presented different virtual prize wheels (or other sweepstakes mechanisms) at different times (e.g., according to different schedules).

In all of the examples described herein, some or all of the cash prizes associated with outer wheel 44 may be replaced with other prizes, such as merchandise, services, trips, additional spins, etc. In the case of cash prizes, winnings may be distributed to the player by deposit to an existing player account, to a bank account designated by a player, to another financial institution account designated by the player (including an on-line account at a financial service provider such as PAYPAL), or by check. Other prizes may be shipped to the player at a designated address or, in the case of prizes amenable to distribution by way of email, through email. Alternatively, or in addition, players may be invited to collect their prizes in person at a designated location, such as the office of the service provider.

Determining which cash prize will populate a cash prize segment, and, hence, the corresponding rotations of inner and outer wheels 42 and 44, is performed by server 12 using one or more pseudo-random number generators. The virtual spin wheel segments and cash prize indicators are tokenized and the output(s) of the pseudo-random number generator(s) is(are) compared to the tokens to determine the cash prize that will populate a given cash prize segment. Similarly, the determination of which prize is awarded to a player in a given spin of the virtual prize wheel is made on the basis of the output of a pseudo-random number generator. The virtual prize wheel segments are tokenized and the output of the random number generator determines where the virtual prize wheel will stop (i.e., which segment will be indicated by indicator 50). In advance of any wheel spins, the service provider assigns winning percentages to the various prizes (much in the same way winning percentages are programmed for a casino slot machine) and those percentages are used to produce seeds to control the output of the pseudo-random number generator.

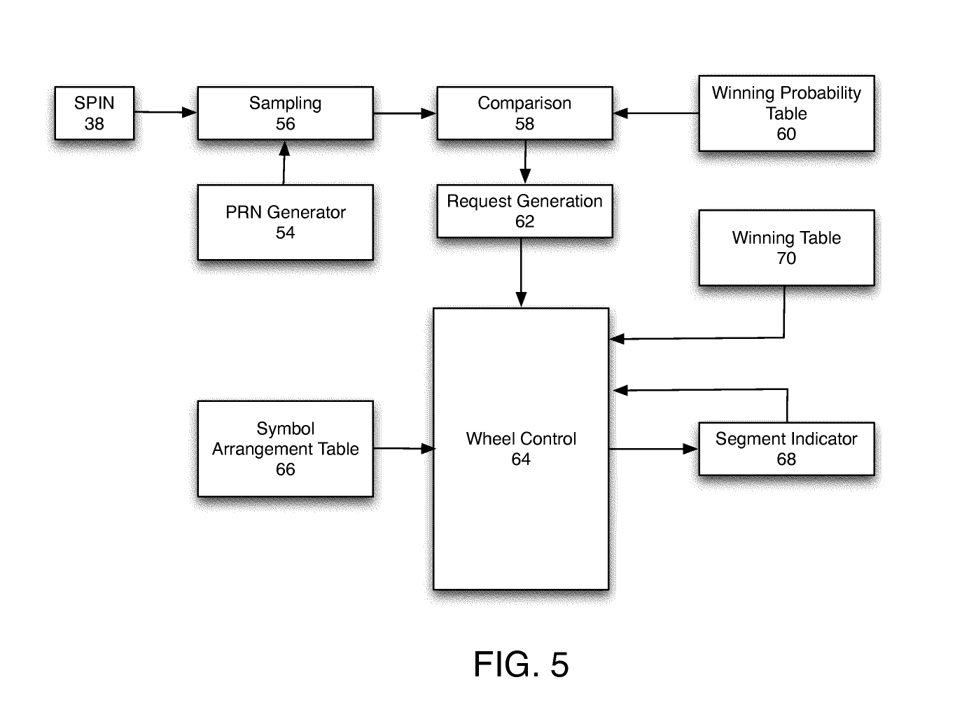

FIG. 5 illustrates an example of how the virtual prize wheel is controlled. At any time instant when the spin button 38 is actuated (or when the wheels are spun by server 12), the pseudo-random number (PRN) generator 54 is sampled 56. The sampled value is compared 58 against a winning probability table 60 to generate a request 62. Through reference to a symbol arrangement table 66 (which stores the assignment of prizes to segments) and a winning table 70 (which stores the service provider's designated pay table for the virtual prize wheel), the wheel controller 64 stops the wheel so the corresponding segment (i.e., the segment that corresponds to the request based on the generated PRN) appears under the segment indicator 68. The spinning of the wheel on the screen is a simulated graphical effect for the entertainment of the player rather than an actual determination of the winning segment.

Returning to FIG. 3, information panel 34. In one embodiment, designators 36 in information panel 34 may specify the schedule for modifying the virtual prize wheel and/or possible cash prizes associated therewith, as reflected in Table 1. For example, the designators may be calendar days or the number of days until the next update of the virtual prize wheel.

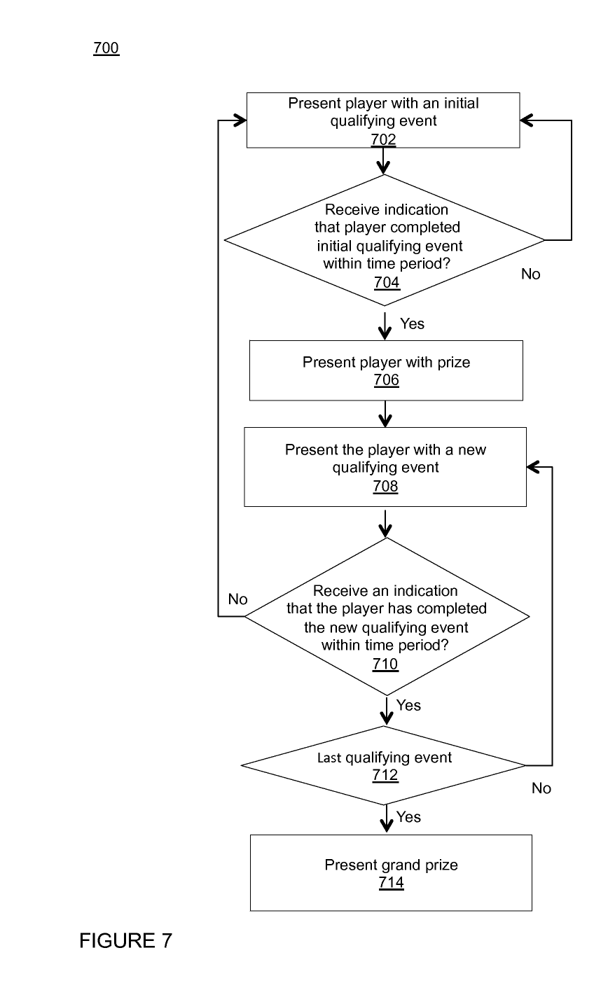

FIG. 7 provides a process 700 for presenting a sweepstakes opportunity to a player by, for example, a host computer via a web site. Process 700 may be executed by one or more components described herein. In some instances, presentation/execution of process 700 may serve to generate player interest in visiting the website and/or improve player loyalty by, for example, varying the prizes available to be won or offering prizes of greater value for players who repeatedly visit the website.

Full participation in the sweepstakes opportunity so as to win a grand or jackpot prize may require a player to complete a series or set of qualifying events within a given time period (e.g., a month or year). The set of qualifying events may include multiple qualifying events, each of which may be associated with a time period for completion (e.g., a day or hour). In some instances, a player may access the web site providing the sweepstakes opportunity repeatedly in order to be presented with new qualifying events. Qualifying events may include, for example, a task (e.g., viewing an advertisement, visiting the web site, and/or taking a survey), a single game, a plurality of different games, and/or multiple instances of a game. Exemplary games included in a qualifying event are games of chance like scratch card games or spinning a virtual game wheel, and games of skill like trivia games or strategy games. In some embodiments, a player may be able to select one or more characteristics of a qualifying event (e.g., type, theme, preferred prize, etc.).

Often times, qualifying events within a particular set are to be sequentially completed by the player such that when the player completes an initial qualifying event, a subsequent qualifying event is presented to the player. In this way, the qualifying events of a set are presented to the player one at a time and not all at once. Often times, a new qualifying event is presented to the player at the conclusion of a time period associated with a previous qualifying event. For example, if a first qualifying event must be completed within 24 hours, a second qualifying event may not be presented to the player until the 24-hour period expires regardless of when within the 24 hour period the player completed the first qualifying event. In this way, the player loyalty is encouraged by multiple visits to the website over a series of days.

In some instances, a new qualifying event is presented to a player in exchange for the player viewing, or otherwise participating in, a media presentation (e.g., a video clip or quiz). The media presentation may be in the form of an advertisement and may be associated with a sponsor of the sweepstakes opportunity.

The qualifying events may be arranged in an order within the set. For example, the qualifying events may arranged according to a schedule that is relative to the set of qualifying events and/or a calendar. When the arrangement of qualifying events is relative to the set of qualifying events, qualifying events may be arranged according to a difficulty and/or complexity level of the qualifying events such that a player is presented with ever more difficult/complex qualifying events as the player progresses through the set of qualifying events. When the arrangement of qualifying events is relative to a calendar, qualifying events may be arranged according to specific dates (e.g., a start date or a particular day of the year). At times, the sets of games and/or qualifying events may be associated with a theme (e.g., sports or a geographic destination), which may, in some instances be dictated by a calendar (e.g., a holiday theme).

In some embodiments, a player may be presented with a visual representation of his or her progress through the set of qualifying events. This visual representation may serve to encourage player loyalty by providing the player with an indication of progress toward the goal of completing the set of qualifying events. The visual representation may provide various forms of encouragement to a player, such as graphic images, audio-visual presentations, or text as they progress through completion of the set of qualifying events. Exemplary visual representations include a count down, chart, graph, table, and/or map.

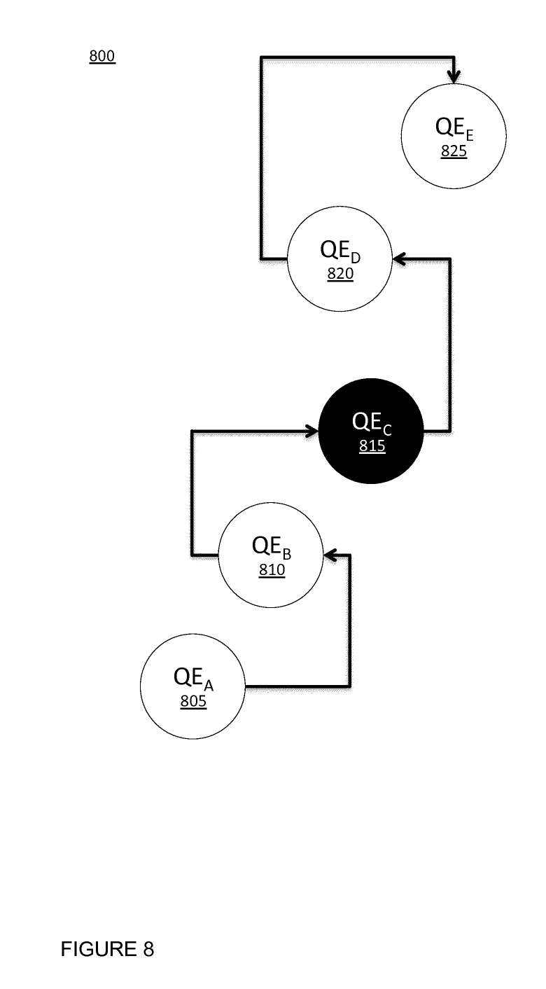

For illustrative purposes, an exemplary visual representation of a player's progress through a set of qualifying events QE_{A-E} 805-825 is depicted as a map 800 as shown in FIG. 8. The qualifying events included within of set QE_{A-E} 805-825 may be identical to, or different from, one another according to various criteria (e.g., player preference, rules of the game, etc.). For example, a difficulty level of the qualifying events may increase as a player progresses through the set so that QE_{A} 805 is easier that QE_{B} 810, and so on. In another example, a theme of the qualifying events may correspond to a schedule (e.g., a calendar, an event, or number of qualifying events completed) and as the player progresses in completing the qualifying events, one or more characteristics of the qualifying events may change according to the theme. For instance, when the theme is a sporting event, each different qualifying event QE_{A-E} 805-825 may be adapted to correspond with a different aspect of the sporting event (e.g., pre-game, post-game, trivia, etc.).

Map 800 may also include arrow lines showing how progress through completion of QE_{A-E}805-825 may be achieved. The present position of the player participating in process 700 (i.e., QE_{C}815) is depicted on map 800 as being of a different color (i.e., black instead of white), although a skilled artisan will recognize that any visual distinction (e.g., pattern, size, shape, a graphic image, mouse over, etc.) may be used to provide a visual representation of a player's current position within a set of qualifying events. When the player successfully completes QE_{C}815, map 800 may be modified to indicate the player has progressed to the next qualifying event of the set (i.e., QE_{D} 820) by, for example, changing the color of the visual representation of QE_{D} 820 from white to black and changing the color of the visual representation of QE_{C}815 from black to white. Map 800 may also be modified to display when a player has failed to successfully complete a qualifying event or when a player's progress thorough the set of qualifying events has regressed.

In some instances, a plurality of sweepstakes opportunities may be presented to the player. The sweepstakes opportunities of the plurality may have varying characteristics such as an overall theme (e.g., a holiday, a climate type (e.g., artic or tropical), a sporting event, etc.), a type of qualifying event associated with the sweepstakes opportunity (e.g., a game to be played or task to be completed) or quantity of qualifying events to be completed by the player for completion of the sweepstakes opportunity. Additionally, or alternatively, a player may select sweepstakes opportunities to participate in based on a final prize and/or intervening prizes offered to the player for participation in the sweepstakes. Also, in some instances, qualifying events included within a sweepstakes opportunity may be partially or fully player configurable. For example, a player may select the types of qualifying events he or she prefers to complete as part of participation in the sweepstakes opportunity.

Upon receiving an indication that a player would like to participate in a sweepstakes or a selection of one of the sweepstakes opportunities and/or a preferred qualifying event, an initial qualifying event corresponding with the selected sweepstakes opportunity may be presented to the player, as in step 702.

Optionally, when an indication that the player has completed the initial qualifying event within the time period associated with in step 704 is received, the player may be presented with a prize (step 706). Exemplary prizes include sponsored items (e.g., products or services), coupons, sweepstakes tickets, invitations to participate in other qualifying events which may, or may not, be included within the set of qualifying events, cash, trips, merchandise, passes or other tokens that allow for free game play (or other services) at the associated web site (e.g., games of chance, other sweepstakes, entertainment games, etc.), etc.

Often times, the prize presented at step 706 may be of lesser value than the prize presented following completion of the set of qualifying events (e.g., at step 714). On some occasions, the prize presented at step 706 may vary according to a schedule (e.g., calendar, season, holiday, etc.).

Whether the player is presented with a prize in step 706 or not, the player may be presented with a new qualifying event to be completed within a particular time period (step 708) following step 704 and/or 706. The new qualifying event may be predetermined and/or dynamically generated as needed. In some instances, the new qualifying event may be presented to the player only after expiration of a given time period associated with, for example, a previously presented qualifying event or a schedule. At times, the player may be presented with the new qualifying event in exchange for performing an action, such as viewing of an advertisement or participating in a survey.

In step 710, it may determined whether an indication that the player has completed the new qualifying event presented at step 708 within the time period associated with the new qualifying event has been received. When the indication has not been received, the player may be presented with a previously presented event, such as the initial qualifying event of step 702, a qualifying event previously presented at step 708 and/or a new qualifying event. In some instances, the player may be disqualified from participating in future qualifying events.

When the indication has been received, it may be determined whether the completed qualifying event is for the last qualifying event of the set (step 712) and, if so, process 700 may proceed to step 714, which is the presentation of the final or grand prize. On some occasions, the prize presented at step 714 may vary according to a schedule (e.g., calendar, season, holiday, etc.).

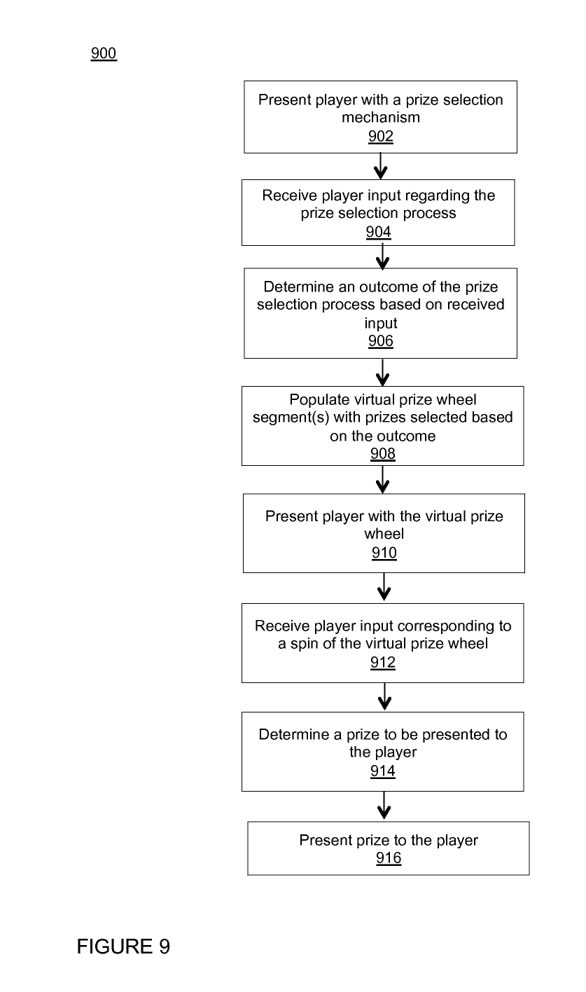

FIG. 9 provides a process 900 for presenting a sweepstakes opportunity to a player by, for example, a host computer via a web site. Process 900 may be executed by one or more components described herein. In some instances, presentation/execution of process 900 may serve to generate player interest in visiting the website and/or improve player loyalty.

Initially, a player may be presented with a prize selection mechanism (step 902) via which player input regarding the prize selection process may be received (step 904). The prize selection mechanism may be presented to the player by, for example, a host computer via a website and, at times, the prize selection mechanism may be presented to the player in exchange for the player viewing an advertisement or participating in a task (e.g., taking a survey). The presented prize selection mechanism may take a variety of forms, such as a game of chance, a game of skill, and/or a sweepstakes. In some instances, the prize selection mechanism may be partially player configurable. An outcome of the prize selection process may then be determined based on the received player input (step 906) and used to populate one or more segments of a virtual prize wheel, such as virtual prize wheel 32 (step 908).

In some embodiments, the virtual prize wheel may be partially populated with prizes available to be won by the player prior to execution of step 902. At times, the virtual prize wheel may include an inner wheel and an outer wheel. The inner wheel and outer wheel may include the same or different prizes and may spin independently of one another during the spin of the virtual prize wheel. In some instances, the prizes available to be won by the player in the inner wheel may be pre-populated and the prizes available to be won by the player in the outer wheel may be populated based on the outcome of the player input received at step 904.

In some instances, the prizes on the virtual prize wheel available to be won by the player, the number of virtual prize wheel segments on the virtual prize wheel, the values of the prizes available to be won by the player, and the number of virtual prize wheel segments on the virtual prize wheel to be populated with cash prizes may be varied and/or updated according to a schedule.

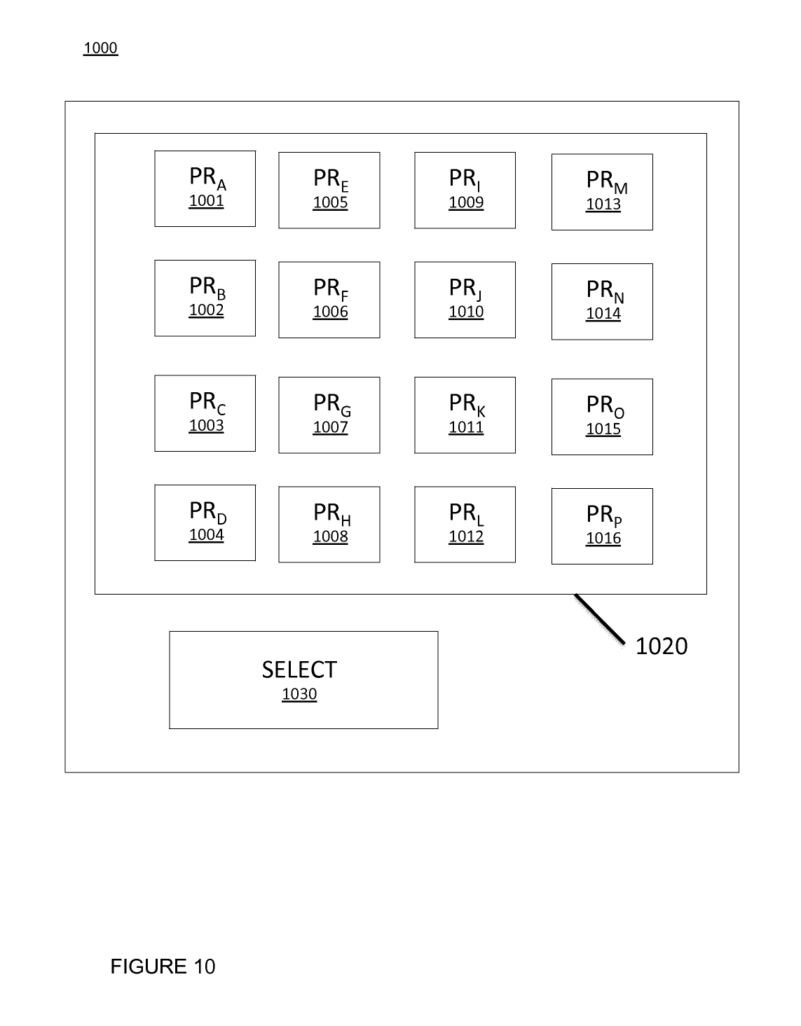

An exemplary prize mechanism 1000 is illustrated in FIG. 10, wherein different prizes and/or prize selection criteria to be selected by the player PR_{A}-PR_{P} 1001-1016 are presented in an array 1020. At times, one or more of prizes PR_{A}-PR_{P} 1001-1016 may be visible to the player, (i.e., the prize to be placed on the virtual prize wheel is clearly visible) while at other times, one or more of prizes PR_{A}-PR_{P} 1001-1016 to be placed on the virtual prize wheel may be hidden from the player by, for example, an image. In some instances, the one or more prizes PR_{A}-PR_{P} 1001-1016 may become visually distinguishable (e.g., flash on and off or change color) or be pointed to in a random or pseudo-random fashion. The player may then select a visually distinguishable or pointed to prize PR_{A}-PR_{P} 1001-1016 via activating a select button 1030 and such a selection may correspond to the player input received in step 904.

In step 910, the virtual prize wheel is presented to the player by the host computer via, for example, the website. In some instances, the virtual prize wheel may be presented to the player in exchange for the player viewing an advertisement. Player input corresponding to a spin of the virtual prize wheel may then be received (step 912) and a prize to be presented to the player may be determined based on the player input (step 914). Exemplary prizes include cash, coupons, tokens, sweepstakes tickets, and entry into contests. The prize may then be presented to the player (step 916) and process 900 may end.

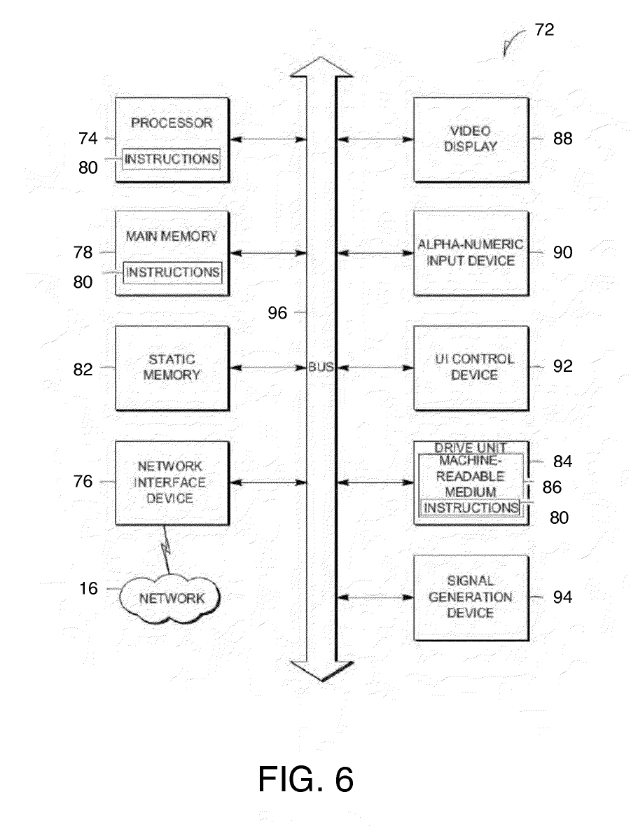

As evident from the foregoing discussion, one or more of the methods or processes described herein may be executable on various computer-based devices (e.g., clients 14a-14n and/or server 12). Such devices, an example (72) of which is illustrated in FIG. 6, may include any electronic device capable of performing the actions described above (using suitable programming) and, where applicable, processing the information for display so as to properly convey the information. Examples of such devices include desktop computers, laptop computers, cellphones, smart phones, tablet computers, computer game consoles, portable computer gaming consoles, media players, portable media players, other mobile devices, and the like.

In such devices, a processor 74 may control the overall functions of the electronic device such as running applications and controlling peripherals. Such a processor may be any type of processor and may communicate (e.g., via bus 96) with network interface device 76 to transmit and receive signals (e.g., cellular, Bluetooth, Wi-Fi, WiLAN, or other communication signals) over a network 16. The processor may use main memory 78 and/or a cache to store operating instructions 80 and to help in the execution of the operating instructions (e.g., such as the temporary storage of calculations and the like). The processor may also use non-transitory storage 82 and/or long-term storage 84 (such as a flash drive, hard disk or other unit comprising a tangible machine readable medium 86) to store and read instructions, files, and other data that requires long term, non-volatile storage.

The processor may communicate and control other peripherals, such as a display 88 with associated touch screen sensor, causing images to be displayed on the display and receiving input from the touch screen sensor when a user presses on the touch-screen display. In some examples, a touch screen sensor may be a multi-touch sensor capable of distinguishing and processing gestures.

The processor may receive input from a physical keyboard 90 and/or mouse/touch pad 92. In other examples, the device may utilize a touch screen keyboard using the display and touch screen sensor. The processor may produce audio output and other alerts that are played on a speaker or other signal generation device 94. A microphone (not shown) may be used as an input device for the processor to receive commands using voice-processing software. In the case of a client 14, an accelerometer may provide input on the motion of the device to the processor. An accelerometer may be used in motion sensitive applications, or, for example, in connection with scrolling content using tilting gestures, etc.

A Bluetooth module may be used to communicate with Bluetooth-enabled external devices. A USB port may enable external connections to other devices (e.g., mice or other cursor control devices) supporting the USB standard and charging capabilities. An external storage module may include any form of removable physical storage media such as a flash drive, micro SD card, SD card, Memory Stick, and the like.

Certain embodiments are described herein as including logic or a number of components, modules, or mechanisms. Modules or components may constitute software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software-as-a-service” (SaaS) service. For example, at least some of the operations may be performed by a group of computers (as examples of machines including processors), with these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. For example, the code can be stored on one or more non-transitory, or non-volatile tangible computer-readable media, and may be loaded into volatile media during execution or at other times (e.g., during a transfer between storage devices, etc.). Examples of these tangible computer-readable media can include, but are not limited to, hard disks, removable magnetic disks, removable optical disks (e.g., compact disks and digital video disks), magnetic cassettes, memory cards or sticks, read only memories (ROMs), flash memories or other solid state devices (SSDs) and the like.

What is claimed is:

1. A method of presenting a sweepstakes opportunity to a player by a host computer via a website, the method comprising:
presenting a player with an initial qualifying event of a set of qualifying events, the qualifying events of the set to be sequentially completed by the player, each qualifying event of the set being associated with a time period for completion;
sequentially presenting to the player a new qualifying event upon receipt of an indication that the player successfully completed a previously presented qualifying event within the time period associated with the previously presented qualifying event until each qualifying event of the set is successfully completed by the player; and
presenting a prize to the player upon receipt of an indication that the player has successfully completed the set of qualifying events or, upon failure to receive an indication that the player has successfully completed a previously presented qualifying event, presenting the player with at least one of a new event and a previously presented qualifying event.

2. The method of claim 1, wherein the new qualifying event is presented to the player following an expiration of the time period associated with the previously presented qualifying event.

3. The method of claim 1, wherein each qualifying event is associated with a difficulty level and each new qualifying event is associated with a difficulty level that is higher than a difficulty level associated with the previously presented qualifying event.

4. The method of claim 1, further comprising:
presenting a visual representation of the qualifying events the player has successfully completed to the player.

5. The method of claim 1, further comprising:
dynamically generating the new qualifying event upon receipt of the indication that the player has successfully completed a previously provided qualifying event prior to presenting the new qualifying event to the player.

6. The method of claim 1, wherein at least one of the qualifying event and the set of qualifying events is configurable by the player.

7. The method of claim 1, wherein the player is presented with the new qualifying event in exchange for the player viewing an advertisement.

8. The method of claim 1, further comprising:
presenting prizes to the player prior to completion of the set of qualifying events by the player.

9. The method of claim 1, further comprising:
varying content for the qualifying events included within the set of qualifying events according to a schedule.

10. The method of claim 1, wherein each qualifying event is associated with a difficulty level and, the method further comprising:
varying a level of difficulty of the qualifying events according to a schedule.

11. The method of claim 1, further comprising varying the prize according to a schedule.

12. The method of claim 1, wherein at least one of the qualifying events includes a plurality of different games to be completed by the player.

13. The method of claim 1, wherein the prize is a ticket for entry into a sweepstakes.

14. A method of providing a sweepstakes opportunity to a player by a host computer via a website, comprising:
presenting the player with a virtual prize wheel comprising a plurality of segments, a first number of which segments of the virtual prize wheel are populated with prizes available to be won by the player and a second number of the virtual prize wheel segments to be populated with prizes selected according to an outcome of a prize selection process;
presenting the player with a virtual prize selection mechanism for generating the outcome of the prize selection process;
upon receiving the outcome of the prize selection process, populating the second number of the virtual prize wheel segments with prizes determined according to the outcome of the prize selection process;
as a result of a spin of the virtual prize wheel awarding a sweepstakes prize determined by an outcome of the spin to the player.

15. The method of claim 14, wherein the second number of the virtual prize wheel segments is populated with cash prizes determined according to the outcome of the prize selection process.

16. The method of claim 14, wherein the virtual prize wheel comprises an inner wheel and an outer wheel, the inner wheel and the outer wheel being made up of the virtual prize wheel segments, wherein both the inner wheel and the outer wheel spin independently of one another during the spin of the virtual prize wheel.

17. The method of claim 14, wherein the player is presented with at least one of the prize selection mechanism and the virtual prize wheel in exchange for the player viewing an advertisement.

18. The method of claim 14, further comprising varying at least one of the prizes on the virtual prize wheel available to be won by the player, the number of virtual prize wheel segments on the virtual prize wheel, the values of the prizes available to be won by the player, and the number of virtual prize wheel segments on the virtual prize wheel to be populated with cash prizes according to a schedule.

19. The method of claim 14, wherein the prize is a ticket for entry into a sweepstakes.

20. A computer-hosted sweepstakes, comprising a virtual prize wheel game in which a virtual prize wheel having segments populated with prizes available to be won by a player and a virtual prize selection mechanism for generating an outcome of a prize selection process are presented to a player via a web site hosted at a computer system; an outcome of the prize selection process determines how one or more segments of the virtual prize wheel are populated; and a spin of the virtual prize wheel determines which of the prizes is won by the player, wherein one or more of the number of virtual prize wheel segments, the number of virtual prize wheel segments populated with cash prizes, and values of the cash prizes are varied according to a predetermined schedule, with the prizes, prize values, and number of virtual prize wheel segments being reset to a set of previous conditions if the player fails to participate in a qualifying event for a virtual prize wheel turn within a designated time period.
